(19) United States
(12) Patent Application Publication
(10) Pub. No.: US 2005/0227901 A1
(43) Pub. Date: Oct. 13, 2005

(54) Device and method for improving the rinse effect of dishwashers

(76) Inventors: Peter Schmiedel, Dusseldorf (DE); Thomas Gassenmeier, Dusseldorf (DE); Rolf Bayersdorfer, Dusseldorf (DE); Wolfgang von Rybinski, Dusseldorf (DE)

Correspondence Address: WOODCOCK WASHBURN LLP, ONE LIBERTY PLACE, 46TH FLOOR, PHILADELPHIA, PA, 19103, US

(21) Appl. No.: 11/147,490

(22) Filed: Jun. 8, 2005

Related U.S. Application Data
(62) Division of application No. 10/872,830, filed on Jun. 21, 2004.
Application No. 10/872,830 is a continuation of application No. PCT/EP02/14100, filed on Dec. 12, 2002.

(30) Foreign Application Priority Data
Dec. 21, 2001 (DE) DE 101 63 668.7

(51) Int. Cl. C11D 17/00

(52) U.S. Cl. 510/433

(57) ABSTRACT

Described herein are devices for improving the rinse effect in machine dishwashers. In one embodiment, the device comprises a means of fixing an amount of liquor comprising rinse surfactant of the main wash cycle, wherein the amount of liquor is sufficient to bring about a rinse effect, whereby the liquor is transported into a subsequent rinse cycle. Also described are methods and kits for achieving a rinse effect in dishwashers.

### CROSS-REFERENCE TO RELATED APPLICATIONS

This application is a continuation of International Application PCT/EP02/14100, filed Dec. 12, 2002, which claims the benefit of German Application No. DE 101 63 668.7, filed Dec. 21, 2001, both of which are incorporated herein by reference in their entireties.

### FIELD OF THE INVENTION

The present invention relates to devices and methods for improving the rinse effect in machine dishwashers.

### BACKGROUND OF THE INVENTION

In the past, considerable efforts have been made to develop cleaning compositions for dishwashers which have selective and defined release kinetics of active ingredients, especially of those which are not intended to become effective until a later stage of the washing cycle, for example rinse agents.

The prior art discloses the provision of the substances to be released with coating materials which dissolve in the cleaning liquor with defined kinetics. Preferred coating materials are, for example, fatty alcohols or fatty acids which may optionally be mixed in a mixture with other coating substances.

A “physical” method for release retardation which is also known is to provide the substance to be released in more sparingly soluble form than the other ingredients. This may be achieved, for example, by the variation of the particle size, since fine cleaning composition ingredients dissolve more rapidly owing to the larger surface area. The combination of ingredients having different degrees of compaction is also a preferred way of realizing different solubilities. For example, pulverulent ingredients may be combined with more highly compressed, for example extruded, alkalizing agents which thus dissolve more slowly.

The “physical retardation of the solution” may also be realized within a tablet. To this end, cleaning composition tablets can be produced which consist of a plurality of phases, one phase being more highly compressed than another phase. The phase having lower compression disintegrates more rapidly in the cleaning cycle into the premixture compressed beforehand, which increases the solubility compared to a harder compressed phase. Frequently, two-layer tablets are used, in which one layer is more loosely compressed than the other, the more intensely compressed layer containing the agent(s) to be released later. Alternatively, the retardation of a phase may also be achieved via a lower content of a disintegration assistant present therein.

It has also been attempted to integrate a rinse agent in cleaning compositions for machine dishwashing, said rinse agent being transported into the rinse cycle over the course of the main wash cycle of the dishwasher by a physical or chemical switching mechanism. However, such a switching mechanism is technologically very complicated and therefore expensive.

Also commercially available are what are known as “two-in-one tablets” which provide adequate amounts of rinse surfactant in the rinse cycle by introducing such large amounts (typically more than 2 grams per tablet) of rinse surfactant into the main cleaning cycle that enough rinse agent still remains in the dishwasher after main and intermediate cleaning in order to bring about a rinse effect. However, such formulations, even for economic reasons, are disadvantageous.

Typically, rinse surfactant is therefore still metered into the cleaning liquor on completion of main cleaning in a separate rinse cycle by the dishwasher. This is likewise unsatisfactory, since the stock of rinse agent in the dishwasher regularly has to be replenished.

It would be advantageous to find a way of realizing a rinse effect even without overdosage of rinse surfactants, without subsequent metering of rinse agent and without complicated switching mechanisms.

### SUMMARY OF THE INVENTION

It has been found that, surprisingly, a rinse effect can be achieved in a dishwasher when the rinse surfactant is added and released as early as in the main wash cycle and entrainment into the rinse cycle is achieved by a suitable device. In certain aspects, the present invention therefore provides a device for achieving or for improving the rinse effect in dishwashers, which fixes a sufficient amount of liquor, comprising rinse surfactant, of the main wash cycle, so that it is not pumped out, but rather transported into the subsequent rinse cycle in each case.

Other features and advantages of the present invention will be understood by reference to the detailed description and the examples that follow.

### DETAILED DESCRIPTION OF ILLUSTRATIVE EMBODIMENTS

Fixing and transport are effected by rinse surfactant being taken up by the inventive device in the main wash cycle until equilibrium with the surrounding cleaning liquor has been attained. In the (relatively short) intermediate rinse cycle, only a little rinse surfactant is flushed out. In contact with the low-surfactant rinse water of the rinse cycle, the entrained surfactant is then released again until equilibrium has once again been established.

The inventive device may in the simplest case be a vessel having one orifice or having several orifices. However, this is not preferred, since contaminants may thus also be entrained and could impair the rinse result.

The device is preferably a porous body, especially a spongelike body, for example a natural sponge, a sponge of polyethylene or polypropylene or a solid open-pore foam such as polyurethane foam or polystyrene foam.

In a further preferred embodiment of the present invention, the porous body is a sinter body, especially a porous ceramic sinter body or a sintered metal.

The use of a porous body has the advantage that, in contrast to entrainment by a vessel, the entrained liquor is filtered through the body. Only liquor but not soil or precipitate present in the wash liquor is thus entrained into the rinse cycle.

The rinse surfactant adsorbs on or in a porous body over its large surface area. More rinse surfactant may thus be transported than only by the entrainment of pure liquor. The entrained liquor is relatively firmly bound in a porous body. It is therefore not fully released in the intermediate rinse cycle and is efficiently transported into the rinse cycle.

The pore diameters of the preferred porous bodies may vary in a wide range. Suitable porous bodies have, for example, average pore diameters in the range of from about 0.001 mm to about 1 mm, preferably from 0.005 mm to 0.5 mm, in particular from 0.01 mm to 0.3 mm, more preferably from 0.01 mm to 0.1 mm.

Small pore diameters are preferred because they ensure good filter action, so that no entrainment of residues and precipitates into the rinse cycle takes place. In addition, the relatively large internal surface area brings about more efficient surfactant transport. The sensible lower limit for the pore diameter can be determined by those skilled in the art from the exchange times of the liquor. When this exchange takes longer than the rinse cycle, the device no longer functions.

The size and the volume of the preferred porous body may be varied within a wide range by those skilled in the art. The required size of the porous body depends upon the amount of rinse surfactant which is released in the main wash cycle, and also upon the retention capacity of the porous structure, which is itself in turn determined by the pore size and the hydrophobicity of the structural material.

The larger the amount transported into the rinse cycle by the porous body, the lower the use amount of surfactant required in the main wash cycle. This would support the use of a very large porous body. However, the sensible size of the porous body has an upper limit in that the efficiency of the washing suffers from the liquor entrainment and that the device becomes too voluminous in the wash chamber.

In practice, the size (volume) of the inventive porous body should be in the range from 10 ml to 750 ml, in particular from 50 ml to 500 ml, preferably from 75 ml to 400 ml and more preferably from 100 ml to 250 ml.

A possible embodiment which is likewise in accordance with the invention is a cavity delimited by a porous body in which filtered liquor can collect.

In a further embodiment of the invention, said cavity delimited by a porous body having filter action is integrated into the machine. This embodiment has the advantage that the device takes up no space in the wash chamber.

In a further embodiment of the present invention, the inventive porous body is disposed in a plastic casing, for example a “dishwasher-resistant” plastic casing, in particular a plastic casing made of polyethylene (PE), polypropylene (PP), polystyrene (PS) or acrylonitrile-butadiene-styrene copolymer of the (ABS). This case has at least one orifice, through which the exchange of the liquor with the wash liquor may proceed. The casing may be secured, for example, to the cutlery basket with a clip.

The present invention further provides a cleaning agent for machine dishwashing which comprises rinse surfactant, the rinse agent being released as early as in the main wash cycle, in conjunction with an inventive device which brings about entrainment of filtered liquor and especially of rinse surfactant into the rinse cycle, i.e. a kit comprising the cleaning agent and the inventive device.

Compared to existing 2- or 3-phase dishwasher tablets, the inventive system features high technical simplicity, since no complicated switching mechanism is required in order to transport the rinse surfactant into the rinse cycle. Nevertheless, no excess of rinse surfactant to be used is required. Regular monitoring and replenishment of a separate rinse stock vessel in the dishwasher is also dispensed with by the use of the inventive device.

The present invention further provides a rinse improvement kit comprising an inventive device and a cleaning agent for machine dishwashing which comprises rinse surfactant, the rinse agent being released as early as in the main wash cycle.

The present invention further provides the use of a device after an inventive device or of an inventive rinse improvement kit for achieving a rinse effect in dishwashers.

The present invention further provides a method for achieving a rinse effect in dishwashers, characterized in that
a) a machine dishwasher cleaning agent is introduced into a dishwasher, said cleaning agent comprising rinse surfactant, and the rinse agent being released as early as in the main wash cycle,
b) an inventive device is introduced into the dishwasher and
c) the wash cycle is allowed to proceed.

### EXAMPLES

The following examples illustrate the invention, but without restricting it thereto.

### Example 1

In a Miele GS 683 SC dishwasher, a wash experiment was carried out using a Somat Profi dishwasher tablet. In addition, 500 mg of the rinse surfactant Polytergent SLF 18B 45 and also 100 mg of the surfactant Texapon ALS IS were metered in the main wash cycle.

A foam sponge having a volume of approx. 150 ml was attached to the cutlery basket.

The surface tensions of the liquors of the cleaning cycle (CC) and the rinse cycle (RC) were measured. The following values were obtained at room temperature and are quoted in 10⁻³ newtons/meter (mN/m):
CC: 31.3 mM/m
RC: 31.7 mM/m

### Example 2

The same experiment was carried out as in Example 1, except without the sponge. The following values were measured for the surface tensions:
CC: 31.3 mM/m
RC: 40.3 mM/m

Comparison of the values shows that, in Example 1, such an amount of rinse surfactant is transported into the rinse cycle that the critical micelle formation concentration is achieved. A rinse effect is thus found. In Example 2, the surface tension has already risen considerably, so that no rinse effect occurs any more.

The disclosures of each patent, patent application and publication cited or described in this document are hereby incorporated herein by reference, in their entirety.

Various modifications of the invention, in addition to those described herein, will be apparent to those skilled in the art from the foregoing description. Such modifications are also intended to fall within the scope of the appended claims.

1-22. (canceled)

23. A method for achieving a rinse effect in a dishwasher, comprising:
entraining a portion of liquor from the main wash cycle, and
allowing the liquor to diffuse into a subsequent rinse cycle,
wherein the liquor includes rinse surfactant.

24. A method for achieving a rinse effect in a dishwasher, comprising:
providing a device having one or more orifices for entraining a portion of liquor from the main wash cycle and allowing the liquor to diffuse into a subsequent rinse cycle, wherein the liquor includes rinse surfactant.

25. The method of claim 24, wherein the device comprises a porous body.

26. The method of claim 24, wherein the device comprises a honeycomb body.

27. The method of claim 25, wherein the porous body comprises natural sponge, polyethylene, polypropylene, solid open-pore foam, sinter body, or a suitable combination thereof.

28. The method of claim 27, wherein the sinter body comprises porous ceramic or sintered metal.

29. The method of claim 27, wherein the solid open-pore foam is polyurethane foam or polystyrene foam.

30. The method of claim 25, wherein the pore diameter of the porous body is from about 0.01 mm to about 0.3 mm.

31. The method of claim 25, wherein the pore diameter of the porous body is from about 0.01 mm to about 0.1 mm.

32. The method of claim 25, wherein the volume of the porous body is from about 75 ml to about 400 ml.

33. The method of claim 25, wherein the volume of the porous body is from about 100 ml to about 250 ml.

34. The method of claim 25, further comprising disposing the porous body in a plastic casing.

35. A method for achieving a rinse effect in a dishwasher, comprising:
placing a device having one or more orifices in the dishwasher; and
allowing the dishwasher to proceed through the main wash cycle to the rinse cycle, wherein the liquor includes rinse surfactant and a portion of liquor from the main wash cycle is entrained in the orifice and diffused during the rinse cycle, providing a rinse effect.
